(19) United States
(12) Patent Application Publication
(10) Pub. No.: US 2007/0274455 A1
(43) Pub. Date: Nov. 29, 2007

(54) Methods and Systems for Analyzing Samples Using Particle Irradition

(75) Inventors: Constantine Tarawneh, Edinburg, TX (US); Nabanita Dasgupta-Schubert, Morelia (MX); Michael Persans, Edinburg, TX (US)

Correspondence Address: FULBRIGHT & JAWORSKI L.L.P., 600 CONGRESS AVE., SUITE 2400, AUSTIN, TX, 78701, US

(73) Assignee: THE BOARD OF REGENTS OF THE UNIVERSITY OF TEXAS SYSTEM

(21) Appl. No.: 11/681,613

(22) Filed: Mar. 2, 2007

Related U.S. Application Data
(60) Provisional application No. 60/778,865, filed on Mar. 3, 2006.

(51) Int. Cl. H05G 2/00

(52) U.S. Cl. 378/177; 378/193; 378/208

(57) ABSTRACT

Systems and methods for an in situ, non destructive analysis of organic or inorganic material are disclosed. In one respect, a particle induced x-ray emission system, having a footprint of less than one square meter, includes a sample holder supporting a sample, a source holder supporting one or more radioactive source and a detector. A radioactive transmission from the one or more radioactive source to the sample results in a fluorescent emission of the sample and collected by the detector. In one respect, fluorescent emission may be used to determine elements found in the sample. Additionally, the amounts of each of the determined elements found in the sample may also be determined.

This application claims priority to provisional patent application Ser. No. 60/778,865 filed Mar. 3, 2006, entitled, “Methods and Systems for Analyzing Samples Using Particle Irradiation” by Tarawneh et al. The entire text of the above-referenced disclosure, including figures, is specifically incorporated by reference herein without disclaimer.

### STATEMENT AS TO RIGHTS TO INVENTIONS MADE UNDER FEDERALLY-SPONSORED RESEARCH AND DEVELOPMENT

Aspects of this invention were made with government support of the National Science Foundation, grant number DBI-0330815. Accordingly, the government may have certain rights in this invention.

### BACKGROUND OF THE INVENTION

1. Field of the Invention

The present invention relates generally to sample analysis. More particularly, the present disclosure relates to methods and systems for in situ, non-destructive analysis of organic or inorganic samples.

2. Description of Related Art

Particle induced x-ray emission (PIXE) systems have generally been used for, among other things, microscopically defining elements with an atomic number of less than 20. These systems can be used to observe planar elemental distributions of a sample to a high degree of quantitative precision and spatial resolution, usually in the order of a micrometer or less. In one respect, a PIXE system can include a high energy particle beam source, typically a proton accelerator delivering protons of energies of a few mega electron volts (MeV) and currents of several nanoamps (nA). The system can also include a micro beam defining electromagnetic focusing system, a sample mounting chamber, an x-ray spectrometric analysis system and data processing computers with data acquisition software.

While a conventional PIXE system can provide some analysis of samples, the current design has many limitations. The most significant drawbacks include their size and the cost of the individual components. These limitations have restricted the use of the PIXE system to private and research domains located in remote locations. Therefore, samples are generally limited to frozen or dead samples. The analysis of such samples does not take advantage of the occurrence of elemental redistribution commonly seen in live samples. Additionally, real time information on the dynamics of metal distribution and accumulation found in live samples cannot be obtained.

Another restriction of the conventional PIXE system is that the system requires elaborate sample handling systems, such as a high vacuum for the sample chamber, and for biological samples, elaborate and expensive preparation. The handling system may subject the sample to excessive forces, and may subsequently destroy the sample. Similar to the forces applied by the handling system, the elaborate preparation of the samples may alter the sample, and thus, may cause an inaccurate or an incomplete analysis.

The referenced shortcomings are not intended to be exhaustive, but rather are among many that tend to impair the effectiveness of previously known techniques for analyzing samples using a PIXE system; however, those mentioned here are sufficient to demonstrate that the methodologies appearing in the art have not been altogether satisfactory and that a significant need exists for the techniques described and claimed in this disclosure.

### SUMMARY OF THE INVENTION

The present disclosure provides for systems and methods for a non-destructive, in-situ analysis of a sample. In one respect, a sample comprising metal elements is provided. The sample may be spaced apart from a radiation source supported by a source holder that may direct emission (e.g., particle emission) to the sample. The sample may provide a fluorescent emission that can be qualitatively and quantitatively analyzed. In one embodiment, the qualitative analysis may include detecting the type of metal elements present in the sample and the quantitative analysis may include determining the amounts of the detected metal elements.

In other respects, a source holder is disclosed. The source holder may include a cap, a housing component, and a mount. The housing component may be configured to support at least one radioactive source. Coupled to the housing is the mount, which may be used to position the housing component in a PIXE-L system. A cap, coupled to the source housing, may be used to shield the radiation source (e.g., during transport, storage, etc.).

In some respects, a system for analyzing a sample is provided. The system may include a sample holder, a source holder, and a detector. The source holder, spaced apart from the sample holder may be configured to support one or more radiation sources that may emit a radioactive transmission to the sample, supported by the source holder. The sample may provide an emission that may be detected by a detector coupled to the source holder.

The term “sample” as defined and used throughout the disclosure includes, without limitation, any surface area or volume of a material that can emit radiation detectable by a detector. Examples of a sample include tracheophyte (whole or a portion thereof), spermatophyte (whole or a portion thereof), algae, fungi, tissue samples, cell samples, bacteria, or other organic matter. Alternatively, a sample may include other surfaces that may contain, for example, metal elements.

The term “analysis of a sample” as defined and used throughout the disclosure relates to determining a property that is typical or characteristic of a sample's unique individual atomic, molecular structure, ion distribution, and/or the like. For example, the methods and systems of the present disclosure may determine the types of elements in an un-altered (e.g., not processed or in its native form) sample. Alternatively or in addition to, the methods and systems of the present disclosure may determine a quantitative analysis of how much of an element or elements are present in a sample. Alternatively or in addition to one or both of the above analysis, the methods and systems of the present disclosure may image the distribution of elements in the sample.

The term “radiation emitted by a sample,” “emission from a sample” or the like, as defined and used throughout the disclosure includes any type of photon or particle, including, without limitation, radio waves, microwaves, visible light, infrared radiation, ultraviolet radiation, X-rays, gamma-rays, electrons, positrons, protons, neutrons, neutral particles, alpha particles, charged particles (ions), ionized atoms, ionized molecules, excited molecules, and the like.

The terms “a” and “an” are defined as one or more unless this disclosure explicitly requires otherwise.

The term “substantially,” “about,” and its variations are defined as being largely but not necessarily wholly what is specified as understood by one of ordinary skill in the art, and in one-non and in one non-limiting embodiment the substantially refers to ranges within 10%, preferably within 5%, more preferably within 1%, and most preferably within 0.5% of what is specified.

The term “coupled” is defined as connected, although not necessarily directly, and not necessarily mechanically.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A is a front view of a sample holder and a source holder, in accordance with embodiments of this disclosure.

FIG. 1B is a block diagram illustrating the spatial relationship between a source holder and a sample holder, in accordance with embodiments of this disclosure.

FIG. 2 is a side view of the system of FIG. 1A, in accordance with embodiments of this disclosure.

FIG. 3 is a top view of the system shown in FIG. 2, in accordance with embodiments of this disclosure.

FIGS. 4A and 4B show a source holder assembly, in accordance with embodiments of this disclosure.

FIG. 5 shows components of the source holder assembly of FIG. 4, in accordance with embodiments of this disclosure.

FIG. 6 shows a side view of the components of the source holder assembly of FIG. 4, in accordance with embodiments of this disclosure.

FIG. 7 shows a top view of the components of the source holder assembly of FIG. 4, in accordance with embodiments of this disclosure.

FIG. 8 shows a top view of the components of the source holder assembly of FIG. 4, in accordance with embodiments of this disclosure.

FIG. 9 shows a top view of the source holder assembly of FIG. 4, in accordance with embodiments of this disclosure.

FIGS. 10A, 10B, and 10C show a housing portion, in accordance with embodiments of this disclosure.

FIG. 11 shows a particle-induced x-ray emission laboratory (PIXE-L) system, in accordance with embodiments of this disclosure.

FIG. 12 shows a quantitative graph of elements found in a sample, in accordance with embodiments of this disclosure.

### DESCRIPTION OF ILLUSTRATIVE EMBODIMENTS

The disclosure and the various features and advantageous details are explained more fully with reference to the non-limiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

The present disclosure provides system and method for an on-site, in situ, non-destructive technique for analyzing and/or imaging samples in many different applications including medical, pharmaceutical, material and semiconductor fabrication, forensic analysis, geology, archaeology, optics, chemistry, biology, and the like. In some embodiments, the sample may include tracheophyte, spermatophyte, algae, fungi, tissue samples, cell samples, bacteria, or other organic matter. In other embodiments, the sample may be a dead sample (e.g., frozen, inorganic, etc.). Alternatively, a sample may include other materials that may contain, for example, metal elements.

The disclosure provides a qualitative analysis to determine types of elements that are contained in a sample. In one embodiment, the sample may be an unaltered, native sample, organic sample, or other similar type samples. Alternatively, the sample may be a dead sample, inorganic samples, or other similar type samples. The disclosure also provides a quantitative analysis to determine the amounts of the detected elements present in a sample. The system and method may be sensitive enough to detect trace levels (e.g., some factor of parts per million). In alternative embodiments, the disclosure provides for quantitative imaging of the distribution of the elements in a sample.

In one embodiment, a laboratory based PIXE system (PIXE-L) for the analyses of a wide variety of samples at atmospheric pressure and ambient conditions of temperature and relative humidity is disclosed. The system may include at least one radioactive source, such as, but not limited to, an uptill 1.48 GBq ²⁴⁴Cm sources (Oak Ridge National Laboratories, Oak Ridge, Tenn.) and may be situated in a source holder. The PIXE-L configuration may maximize the available particle flux to a sample and emergent x-ray flux to a detector by optimizing the available surface area of the source in both magnitude and orientation, the source to sample distance, and the sample to detector distance and geometry while ensuring concomitant radiation safety.

The PIXE-L system, having footprint of less than about 1 square meter for easy deployment and on site analysis, may include a sample holder that can be accurately adjusted in three-dimensions to allow quantitative x-ray detector efficiency calibration with appropriately devised standards. This will allow not only x-ray broad aperture imaging but also quantitative analysis. The air column through which the x-rays traverse, naturally acts as filters for low energy x-rays. In some embodiments, no additional components like filters and focusing units are necessary as compared to conventional PIXE system.

In some embodiments, the PIXE-L system may collect emission from a sample (e.g., x-rays) at back angles. Alternatively, the system may provide for transmission mode x-ray spectrometry where a detector is placed behind the sample to collect emitted x-rays. Details of the sample holder, the source holder, and the PIXE-L system are discussed in detail below.

Sample Holder

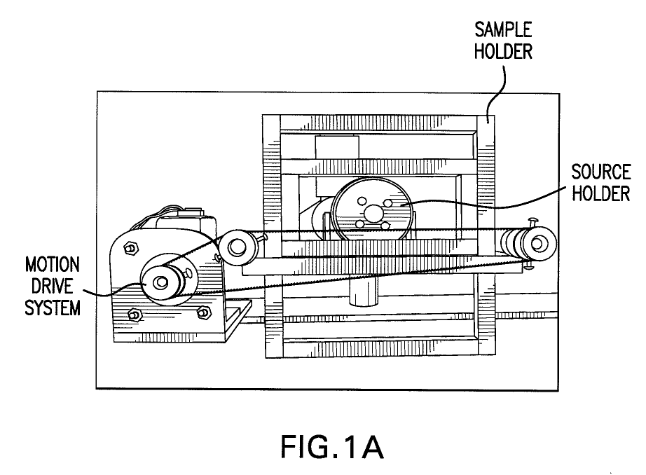

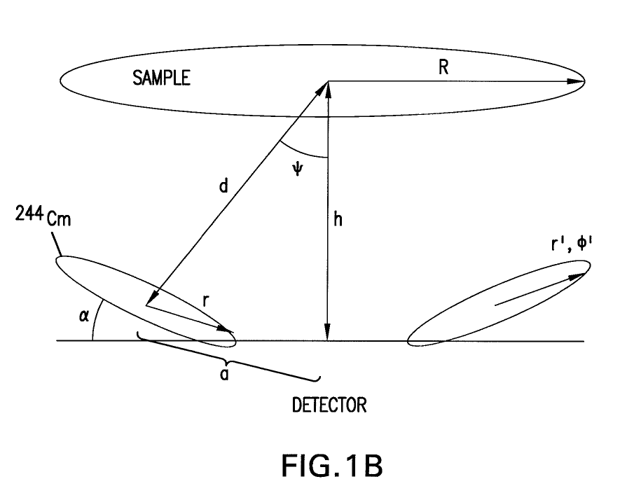

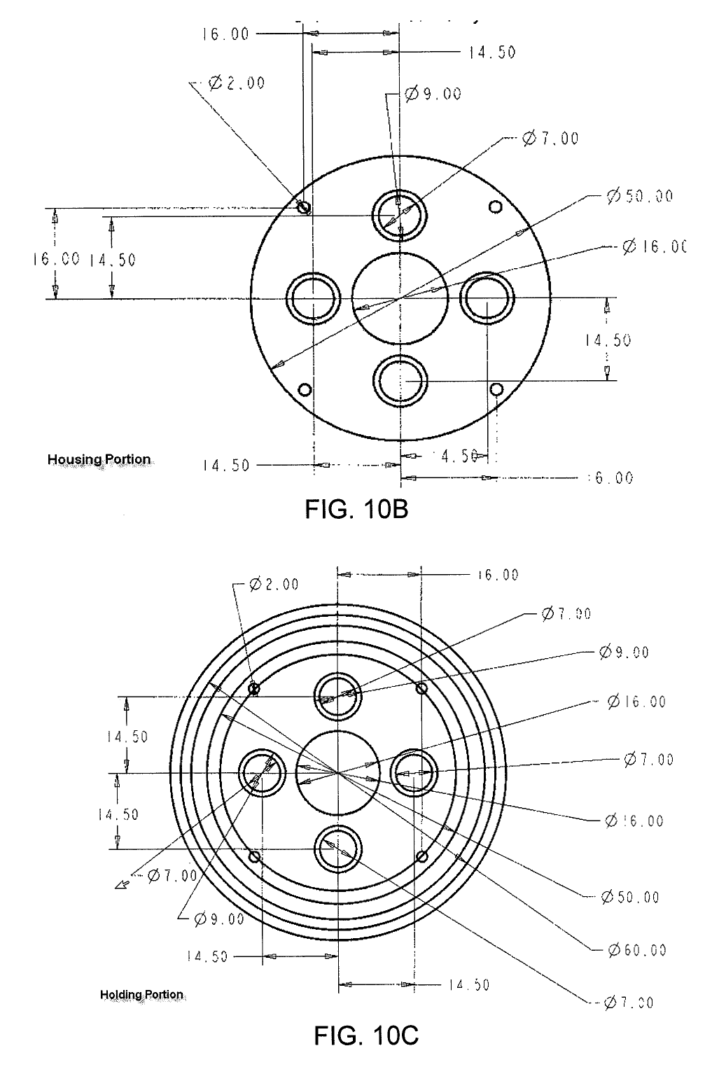

Referring to FIGS. 1 and 2, a sample holder that may be used in a PIXE-L system, in accordance to embodiments of the present disclosure is shown. The sample holder, configured to receive a sample, may provide a substantially vibration free mounting and manoeuvre. In one respect, the sample holder may be coupled to a mechanical drive system for controlling the motion of the sample holder, although other drive systems may be employed to operably move the sample holder. Examples of such drive systems may include, without limitation, a hydraulic system, a pneumatic system, a manual system, a chain operated machinery, air cylinders, ring and pinion gear, an electrical system, other motorized systems known in the art, or a combination of any of the above. A controller (shown in FIG. 11) may be coupled to the drive system to allow for incremental movements (e.g., fractions of a millimetre) in the horizontal or vertical direction. The controller may substitute for human adjustments, thus eliminating human exposure to radiation emitting from radioactive sources of the system.

In one embodiment, the design of the sample holder may allow for a firm affixture to a vibration table, while allowing flexibility in the sample holder. For example, the drive system may be configured to three-dimensionally position the sample holder and at a distance from the source. In one embodiment, the drive system may position the sample holder in a manner allowing for 180° back-reflectance mode x-ray collection from the sample to a detector coupled to the sample. Alternatively or in addition, the sample holder may allow for transmission mode x-ray collection.

In one embodiment, the sample holder may be fabricated using aluminium alloy having a dimension of about 20×20×20 centimetres. Alternatively, the sample holder may be made out of other materials that may be suitable to support a sample and withstand radiation emission. Further, the dimensions of the sample holder is a non-limiting example, and one of ordinary skill in the art can recognize the dimensions may be smaller or larger, depending on the size of the sample.

Source Holder

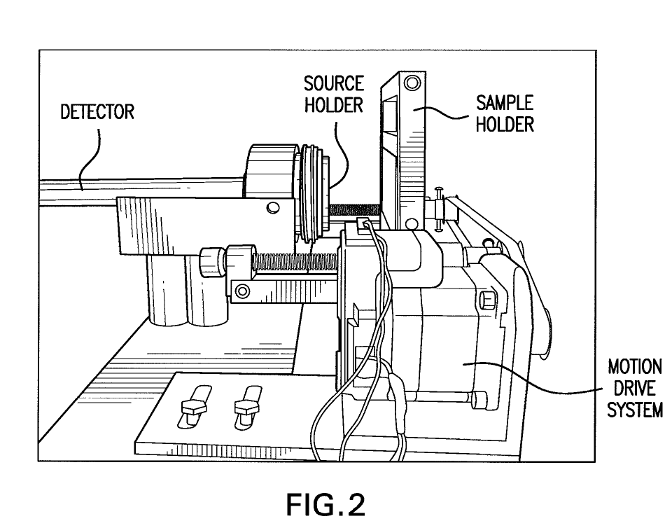

In one embodiment, a source holder may be coupled to the sample holder in a PIXE-L system, as shown in FIGS. 2 and 3. The source holder may be configured to support at least one radiation source for a non-destructive qualitative and quantitative analysis of elements in a sample. In one embodiment, the source may be one or more mono-energetic ²⁴⁴Cm alpha source of about 5.6 to 5.8 Mega electron volts (MeV). Alternatively, the source holder may support other radiation sources such as, but not limited to, electron, positron, and/or gamma sources.

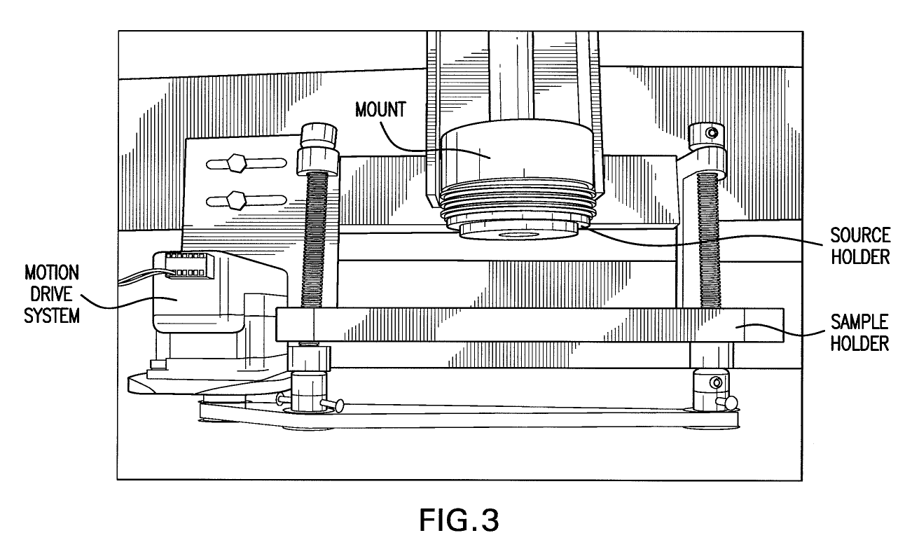

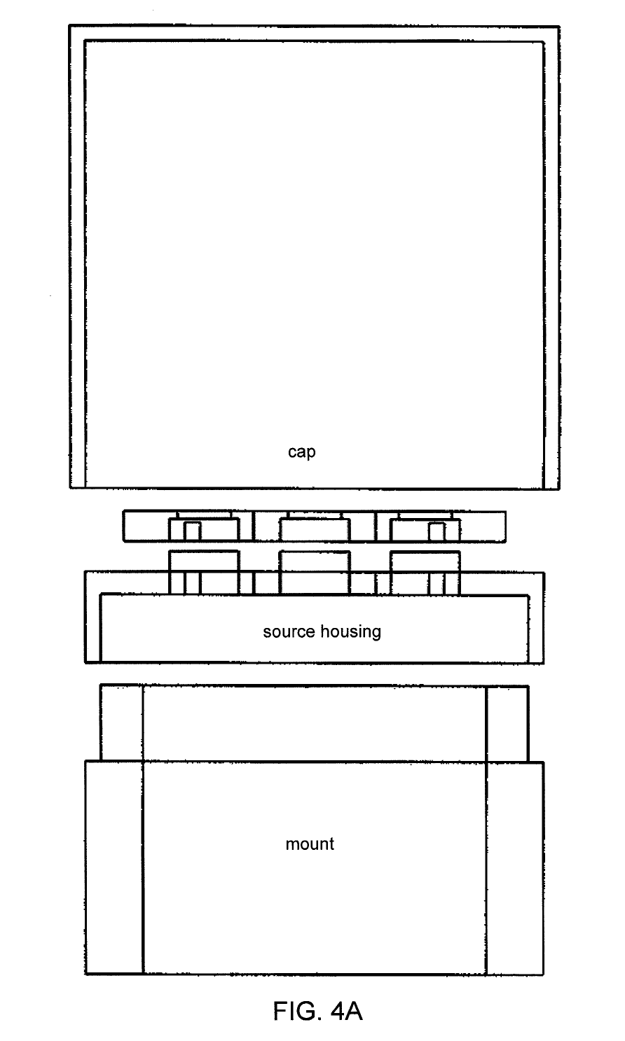

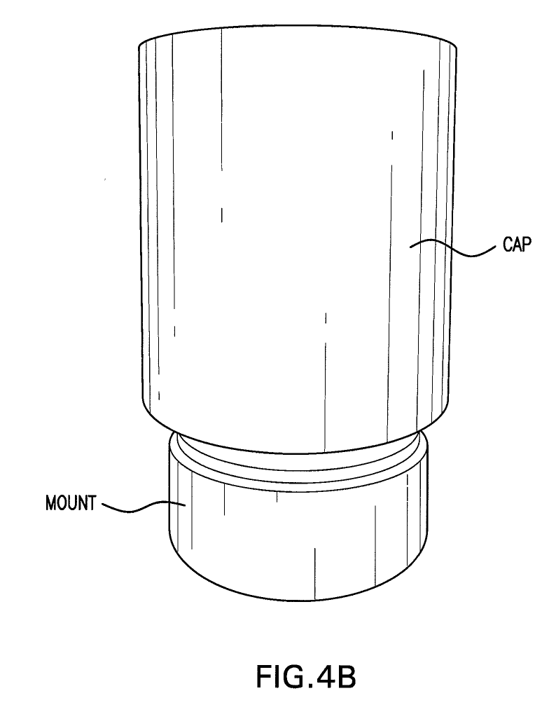

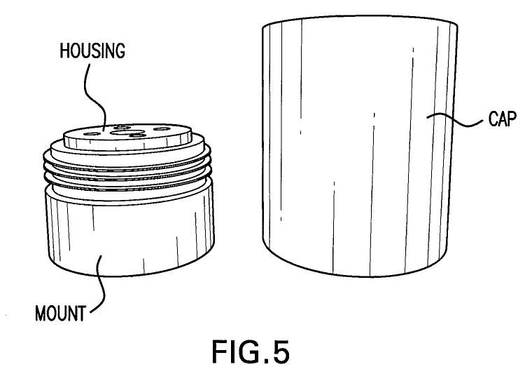

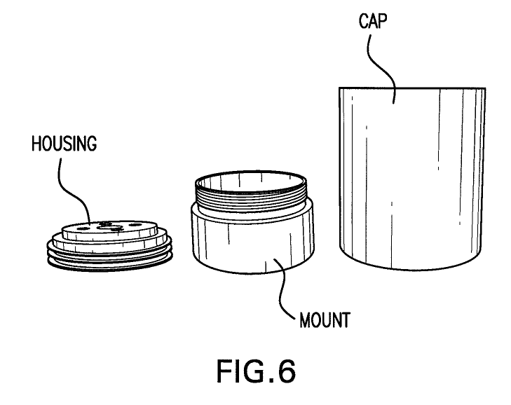

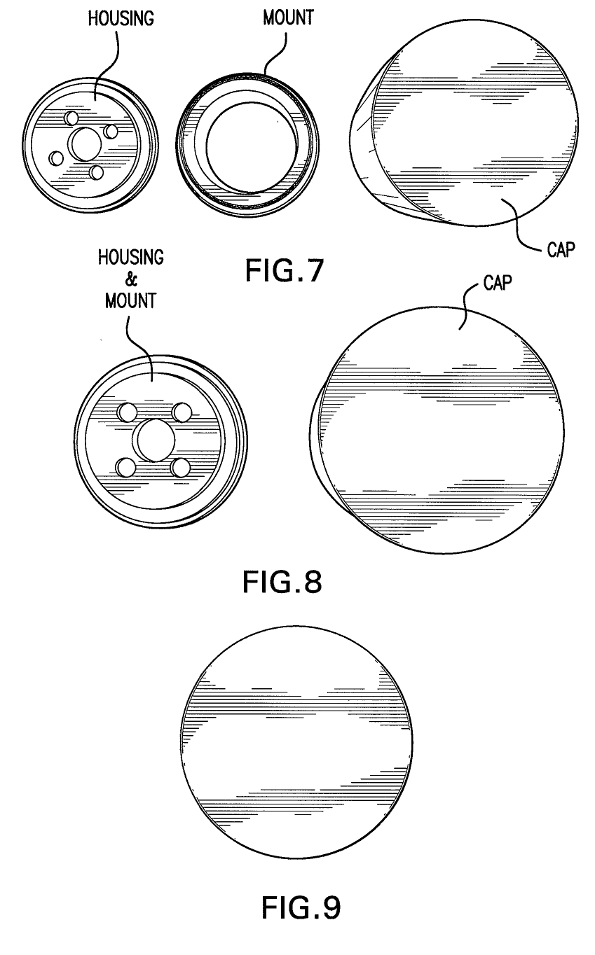

Referring to FIGS. 4 through 9, multiple views of a source holder are provided where the source holder includes a housing component, a mount, and a cap. The source holder may be manufactured from an aluminium alloy, although other materials suitable for supporting and shielding radiation particles may be used. In one embodiment, the source holder may be in the range of about 70-90 millimetres in diameter and about 50-75 millimetres in height. The dimensions provided are a mere example, and one of ordinary skill in the art can recognize other dimensions may be used, and in particular, dimensions allowing for portability such that in-situ analysis may be performed.

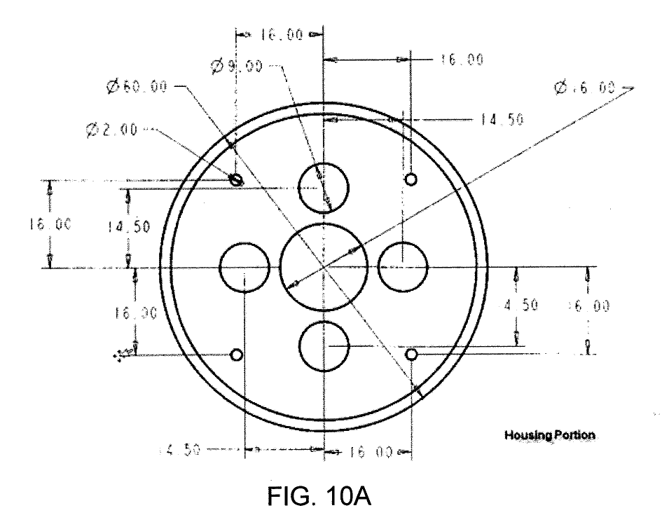

In one embodiment, the source holder may include a housing portion for supporting at least one source. In the corresponding figures, this portion is shown to house 4 sources. However, one of ordinary skill in the art can recognize that the number of sources may vary by changing, for example, the exemplary dimensions of the housing portion shown in FIGS. 10A, 10B, or 10C.

The source holder may also include a mount portion for securing the sources during data acquisition. For example, referring again to FIG. 2, the mount portion may be mounted on a stand in the PIXE-L stand.

In one embodiment, a cap may also be provided and may be configured to shield the source during storage. The cap may have a height of about 4 centimetres or greater, allowing for the reduction or elimination radioactive dust created from the alpha sources. One of ordinary skill in the art may recognize that the height of the cap may vary based on the source used and any safety factor used to ensure and radioactivity is absorbed by the cap.

The cap may include grooves that fit into the source housing portion, such that the source or sources or not exposed during storage. In other embodiments, the cap and/or mount may include fasteners, adhesives, or the like to secure the housing component within the mount and cap.

A PIXE-L System

Referring to FIG. 11, a PIXE-L system setup is shown. In one embodiment, the PIXE-L system may include a detector such as a Si(Li) detector, although other suitable detectors known in the art may be used. In one configuration, the detector may be coupled to a source holder. In other configurations, the detector may pass through an opening of the source holder, such that the detector and source holder may be an integral unit. Alternatively, the detector may be coupled to the sample holder, preferably behind the sample holder, to collect transmission mode x-rays emitted from the sample.

The detector may also be coupled to a cooling agent to prevent overheating. The cooling agent may include liquid nitrogen, although other cooling agents known in the art may be used.

Coupled to the PIXE-L system may be a data acquisition system. In one embodiment, the data acquisition may include a processor configured to receive, for example, spectral data from a detector. In other embodiments, the processor may provide instructions to the PIXE-L and may control the functionalities of the system (e.g., providing instructions to the controller for positioning of the sample holder). The processor may be any computer-readable media known in the art. For example, it may be embodied internally or externally on a hard drive, ASIC, CD drive, DVD drive, tape drive, floppy drive, network drive, flash, or the like. The processor is meant to indicate any computing device capable of executing instructions for receiving the data from detector amongst other functions. In one embodiment, the processor is a personal computer (e.g., a typical desktop or laptop computer operated by a user). In another embodiment, the processor may be a personal digital assistant (PDA) or other handheld computing device.

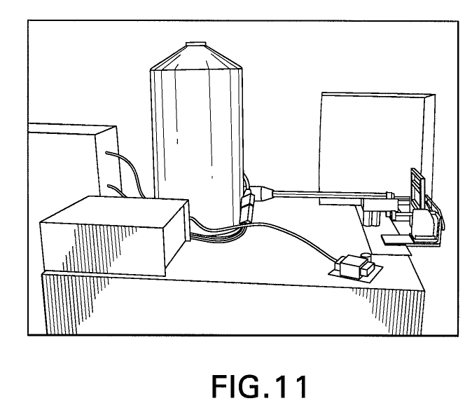

In some embodiments, the processor may be a networked device and may constitute a terminal device running software from a remote server, wired or wirelessly. Input from a user, detector, or other system components, may be gathered through one or more known techniques such as a keyboard and/or mouse. Output, if necessary, may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash drive, or the like. The processor may use any type of monitor or screen known in the art, for displaying information, such as but not limited to, figures similar to FIG. 12 or a quantitative distribution of detected elements in a sample. For example, a cathode ray tube (CRT) or liquid crystal display (LCD) can be used. One or more display panels may also constitute a display. In other embodiments, a traditional display may not be required, and the processor may operate through appropriate voice and/or key commands.

### EXAMPLES

The following examples are included to demonstrate specific embodiments of this disclosure. It should be appreciated by those of ordinary skill in the art that the techniques disclosed in the examples that follow represent techniques discovered by the inventors to function well in the practice of the invention, and thus can be considered to constitute specific modes for its practice. However, those of ordinary skill in the art should, in light of the present disclosure, appreciate that many changes can be made in the specific embodiments which are disclosed and still obtain a like or similar result without departing from the spirit and scope of the invention.

Alpha Emitting Isotopes

The use of a high-strength, alpha emitting isotope can provide a full analysis of a sample, without altering or destroying a sample in a cost-effective and efficient manner. In particular, alpha-emitting isotopes have a naturally larger beam spot size and with intensities that are orders of magnitude lower than in conventional techniques that employ accelerators. Alpha particles can also be beneficial in that their linear energy transfer (LTE) in a medium (e.g., dense air, humid air, or otherwise, ambient air) is higher than proton systems and thus, can afford higher depth resolution and higher ionization cross-sections. Further, an alpha emitting isotope may allow for native state, live sample analysis without providing a radioactive dose that would be fatal to the sample.

1. Organic Matter

Plants are generally radiation resistant, as demonstrated in the aftermath of the Chernobyl nuclear accident in 1984, where about 4.5 billion Curies (1.67×10²⁰ Bq) were released. Plants and lower life forms such as bacteria were the first to recuperate in the devastated landscape. Therefore, the use of low dosage alpha radiation exposure for qualitative and quantitative analysis may not fatally destruct these live forms because the currents of an alpha source are of the order of a few pico Amps. This may allow for analysis of heavy elemental distributions commonly found in live plants over an aperture of about 1.6 centimeters and at the level of tens of parts per million (ppm) in concentration. The time period for analysis may depend on the concentration of elements found in the sample. For several ppm, a maximal period for quantitative elemental analysis and/or imaging may be several hours or less.

In this example, a thalspi montanum var siskiyouense live plant sample, grown in a nickel rich soil was analyzed. In particular, the sample came from a plant that was treated in hydroponics for one week with nickel acetate of about 100 micro molar concentration. The sample had hyperaccumlated the nickel in amount of about 0.5 to 1.5% of its dry mass (about 5000 to 15,000 ppm). Normal values are at about 0.0001 to 0.1% (1 to 100 ppm). Uptill 1.48 GBq ²⁴⁴Cm alpha sources were obtained from Oak Ridge National Laboratories (Oak Ridge, Tenn.) and situated in the source holder of FIG. 11. The source holder may maximize the available alpha flux to the sample and allow emergent x-ray flux from the sample to a detector. A Si(Li) detector was used to collect the emissions from the sample, and an analysis of the sample was performed. As shown in FIG. 12, elements such as potassium (K), thorium (Th), calcium (Ca), iron (Fe), nickel (Ni), and copper nitrate (CuNi) were identified and quantified at various numbers of x-ray counts.

The PIXE-L system of the present disclosure may also allow the studying of heavy metal transport and distribution in real time. This may provide valuable information to, for example, plant biologist and biochemist who study the renewable contamination removal technology of phytoremediation.

Further, the PIXE-L system may be extended to the analysis of other organic materials. For example, for microbiologists, the study of bacteria and fungi may be beneficial, especially with respect to bioremediation technologies.

2. Non-Living System

Since there are no restrictions relating to radiation doses for non-living systems, a whole range of disciplines can benefit from the system and techniques of the present disclosure. For example, the field of solid state and material science, electronic component fabrication and verification, archaeology, biology, chemical, and environmental research, where samples generally include an array of elements may adapt and use PIXE-L system as an in-situ, efficient, and affordable means to analyze samples and/or components.

3. Medical Applications

Several medical conditions may be exacerbated by either an excess or deficiency of key minerals. For example, both high and low levels of heavy metals such as chromium, potassium, and magnesium have been linked to the accelerated development and progression of type-2 diabetes. Similarly, potassium is key element in the control of hypertension. The PIXE-L system and technique may be beneficial to hospitals, doctor offices, and the like to analyze sample tissue with minimal processing and in a non-invasive manner.

4. Food, Drug, and Chemical Applications

Process control in the food, drug, and chemical industries relies on the accurate concentrations of heavy elements. The advantage of a PIXE-L system includes providing a non-destructive and non-invasive technique that can analyze the respective samples within the laboratory. This technique eliminates the processing time found in conventional techniques, as well as allow for substantially dynamic adjustments in food, drug, or chemical applications.

5. Forensics and Security Applications

For samples such as crime scene evidence, the PIXE-L system may provide a non-destructive analysis of the evidence, as thus, preserving the evidence for admittance in court cases. Additionally, the PIXE-L system may provide an on-site analysis, and therefore, can eliminate the introduction of foreign materials or destruction of the evidence generally seen in the collecting and transporting phases of an investigation.

For security applications such as detecting explosives, the PIXE-L system may allow for a fast, inexpensive, robust, and accurate analysis not found in current techniques. The deployment of a PIXE-L system is safe as the radiation is shielded, and the amount of human involvement during the analysis process is minimal, if any.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain compositions which are chemically related may be substituted for the compositions described herein while the same or similar results would be achieved. All such similar substitutes and modifications apparent to those skilled in the art are deemed to be within the spirit, scope, and concept of the invention as defined by the appended claims.

1. A method comprising:
providing a sample comprising metal elements, the sample being supported by a sample holder of a particle-induced x-ray system;
providing at least one source holder from the particle-induced x-ray system, the at least one source holder being coupled to one radiation source spaced apart from the sample;
directing emissions from the source to the sample;
collecting fluorescence emissions from the sample; and
performing an in situ, non-destructive analysis of the sample using the particle-induced x-ray system.

2. The method of claim 1, the sample comprising an organic material.

3. The method of claim 1, the organic material being selected from the group consisting of tracheophyte, spermatophyte, algae, fungi, tissue samples, cell samples, and bacteria.

4. The method of claim 1, the sample comprising an inorganic material.

5. The method of claim 1, the radiation source comprising a radiation source emitting alpha, electron, positron, or gamma particles.

6. The method of claim 1, the radiation source comprising a ²⁴⁴Cm alpha source.

7. The method of claim 1, the step of performing an analysis of the sample comprising detecting the types of metal elements in the sample.

8. The method of claim 7, the step of performing an analysis of the sample further comprising determining a quantity of metal elements detected.

9. The method of claim 7, the step of performing an analysis of the sample further comprising providing an image comprising a quantitative distribution of detected metal elements.

10. The method of claim 1 operably configured for a transmission mode.

11. The method of claim 1 operably configured for a reflective mode.

12. A system comprising:
a sample holder configured to support a sample;
a source holder spaced apart from the sample holder, the source holder configured to support at least one radiation source and adapted to provide transmission mode spectrometry from the at least one radiation source to the sample, the source holder comprising:
a housing component adapted to support at least one radioactive source;
a mount coupled to the housing component, the mount configured to attach to a particle-induced x-ray emission system;
a cap coupled to the housing component, the cap shielding the radioactive source; and
a detector coupled to the source holder for detecting particle-induced emissions from the sample.

13. The system of claim 12, where the source holder and the detector are an integral unit.

14. The system of claim 12, where the source holder is smaller than about 1 square meter.

15. The system of claim 12, further comprising a motion drive system for adjusting the sample holder.

16. The system of claim 12, the detector comprising a Si(Li) detector.

17. The system of claim 12, the source holder comprising a cap for protecting the at least one radiation source.

18. The system of claim 12, the radiation source comprising a radiation source emitting alpha, electron, positron, or gamma particles.

19. The system of claim 12, the radiation source comprising a ²⁴⁴Cm alpha source.

20. The system of claim 12, the radiation source comprising an energy of about 5.6 to about 5.8 MeV.

21. A source holder comprising:
a housing component adapted to support at least one radioactive source;
a mount coupled to the housing component, the mount configured to couple to a particle-induced x-ray emission system;
and a cap coupled to the housing component, the cap shielding the radioactive source.

22. The source holder of claim 21, where the housing component, the mount, and the cap, when combined, has a dimension of less than 90 millimeter in diameter.

23. The source holder of claim 21, where the housing component, the mount, and the cap, when combined, has a dimension comprising a dimension of less than 75 millimeter in height.

24. The source holder of claim 21, the housing component supporting at least one ²⁴⁴Cm alpha source.
